(19) United States
(12) Patent Application Publication
(10) Pub. No.: US 2026/0234425 A1
(43) Pub. Date: Aug. 13, 2026

(54) Additive Manufacturing Of Bijels

(71) Applicant: The Trustees of the University of Pennsylvania, Philadelphia, PA (US)

(72) Inventors: Daeyeon Lee, Wynnewood, PA (US); Kathleen J. Stebe, Penn Valley, PA (US); Philip Iaccarino, Philadelphia, PA (US); Damilola Lawal, Baltimore, MD (US); Jordan R. Raney, Kempton, PA (US)

(21) Appl. No.: 19/532,674

(22) Filed: Feb. 6, 2026

Related U.S. Application Data
(60) Provisional application No. 63/755,535, filed on Feb. 7, 2025.

(51) Int. Cl. C09D 11/037; B29C 64/106; B29K 33/00; B33Y 10/00; B33Y 70/00; B33Y 80/00; C08K 3/36; C08K 5/101

(52) U.S. Cl. CPC C09D 11/037; B29C 64/106; C08K 3/36; C08K 5/101; B29K 2033/08; B33Y 10/00; B33Y 70/00; B33Y 80/00

(57) ABSTRACT

A printable bijel precursor, comprising: a hydrophobic component; an aqueous component; a solvent; a population of hydrophobic particles; and a population of hydrophilic particles, wherein the printable bijel precursor is formulated such that the printable bijel precursor forms a bijel following at least partial removal of the solvent, wherein the printable bijel precursor is characterized as having any one or more of: (a) a viscosity of from about 20 to about 80 Pa*s at a shear rate of 15 sec-1, (b) a storage modulus of from 6000 to about 60,000 Pa at a strain of 0.1%, (c) a loss modulus of from 600 to about 6000 Pa at a strain of about 0.1%, and (d) a loss modulus greater than a storage modulus at a strain of about 20%. A method of additively manufacturing a bijel, comprising: extruding a first amount of a printable bijel precursor according to the present disclosure, the extruding being performed under such conditions that the first amount of the printable bijel precursor forms a first solid persistent bijel portion. The conditions can include, for example, effecting at least partial evaporation of the solvent of the printable bijel precursor. A method of additively manufacturing a bijel part, comprising: extruding, through a nozzle having a diameter, a plurality of layers of a printable bijel precursor according to the present disclosure, the extruding being performed under such conditions that the printable bijel precursor forms a solid persistent bijel part comprising a plurality of bijel layers. A bijel part, comprising: a plurality of layers comprising a persistent solid bijel material, the plurality of layers comprising channels placing the layers into fluid communication with one another.

### CROSS-REFERENCE TO RELATED APPLICATIONS

This application claims benefit to U.S. Provisional Application No. 63/755,535, filed Feb. 7, 2025. All foregoing applications are incorporated herein by reference in their entireties for any and all purposes.

### GOVERNMENT RIGHTS

This invention was made with government support under 1720530 awarded by National Science Foundation and FA9550-23-1-0416 awarded by Air Force Office of Scientific Research. The government has certain rights in the invention.

### TECHNICAL FIELD

The present disclosure relates to the field of additive manufacture and to the field of bicontinuous interfacially jammed emulsions (bijels).

### BACKGROUND

Additive manufacturing allows users to form intricate parts of shapes and dimensions not always attainable using traditional forms of manufacture. Additive manufacturing also allows users to form such parts using materials that have not always been incorporated into such intricate parts.

Bijels are particle-stabilized biphasic structures consisting of an interwoven arrangement of bicontinuous phases, and can be formed by kinetically arresting spinodal decomposition through the attachment and interfacial jamming of particles along the interface of the two phases. The bicontinuous structure of bijels makes them especially attractive for use in a variety of industrial applications, but additive manufacturing of parts that include a bijel portion is challenging, as existing bijel precursors may not in some cases be well-suited for use in additive manufacturing. Accordingly, there is a long-felt need in the art for compositions and methods related to the use of bijels in additive manufacture.

### SUMMARY

In one aspect, the present disclosure provides a printable bijel precursor, comprising: a hydrophobic component; an aqueous component; a solvent; a population of hydrophobic particles; and a population of hydrophilic particles, wherein the printable bijel precursor is formulated such that the printable bijel precursor forms a bijel following at least partial removal of the solvent, wherein the printable bijel precursor is characterized as having any one or more of: (a) a viscosity of from about 20 to about 80 Pa*s at a shear rate of 15 sec-1, (b) a storage modulus of from 6000 to about 60,000 Pa at a strain of 0.1%, (c) a loss modulus of from 600 to about 6000 Pa at a strain of about 0.1%, and (d) a loss modulus greater than a storage modulus at a strain of about 20%.

Also provided is a method of additively manufacturing a bijel, comprising: extruding a first amount of a printable bijel precursor according to the present disclosure, the extruding being performed under such conditions that the first amount of the printable bijel precursor forms a first solid persistent bijel portion. The conditions can include, for example, effecting at least partial evaporation of the solvent of the printable bijel precursor.

Further provided is a method of additively manufacturing a bijel part, comprising: extruding, through a nozzle having a diameter, a plurality of layers of a printable bijel precursor according to the present disclosure, the extruding being performed under such conditions that the printable bijel precursor forms a solid persistent bijel part comprising a plurality of bijel layers.

Additionally disclosed is a bijel part, comprising: a plurality of layers comprising a persistent solid bijel material, the plurality of layers comprising channels placing the layers into fluid communication with one another.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1A: 3D printing fails when using conventional VIPS precursors due to their fluid-like behavior. In these systems, surfactant-modified silica particles are mixed into a one-phase ternary mixture (purple), then quenched into a two-phase region (pink) via ethanol evaporation to form particle-stabilized bicontinuous oil-rich phases (green) and water-rich phases (red).

FIG. 1B: printing is successful when using fumed silica-based emulsion precursors. In these systems, mixtures of hydrophilic (light grey) and hydrophobic (dark grey) fumed silica particles confer ink rheology useful to successful 3D layering of material and inhibition of spreading, and also stabilize bicontinuous structures after quenching.

FIGS. 2A and 2B: Flow sweep rheology reveals yield stress behavior in the stress curve (A) and shear-thinning behavior in the viscosity curve (B). As the fumed silica particle loading increases, both yield stress and fluid viscosity increase. Dashed line represents fit to Hershel-Bulkley model.

FIGS. 2C and 2D: Oscillatory rheology reveals gel-like behavior of the precursor at small amplitudes (C) and a transition to fluid-like behavior at large amplitudes (D). The enhanced yield stress and storage modulus support 3D printing, relative to the conventional VIPS precursor.

FIGS. 2E and 2F: The precursor ink is thixotropic; the transient stepwise viscous response (E) and stress hysteresis loop (F) shows a loss of fluid structure after exposure to high shear rates experienced during 3D printing extrusion.

FIG. 3A: CLSM images of a section from a 3D printed bicontinuous emulsion gel. The green fluorescent signal represents polymerized oil channels and black represents pores from previously evacuated water channels.

FIG. 3B: Cross-sectional SEM series of a 3D printed bicontinuous emulsion gel. Polymer channels are covered with interfacially jammed fumed silica particles and excess particles.

FIG. 3C: Cross-sectional SEM series of a 3D printed bicontinuous emulsion gel after removal of fumed silica particles. After etching, the bicontinuous polymer/pore microstructure is revealed.

FIG. 4A-F: Bicontinuous emulsion gels printed with macroscale morphologies of: high span woodpile grid (A), low span woodpile grid (B), vertical wall (C), vertical rectangular prism (D), starfish (E), and the Philadelphia LOVE sculpture (F). All scale bars represent 1 cm.

FIG. 5A: Emulsions of water and HDA are mixed, with and without FS particles. When FS particles are present, the emulsion remains stable for at least 7 days, as indicated by turbid and cloudy liquid appearance. When particles are not present, the oil-in-water demixes during the 6-day period, as transparency is restored.

FIG. 5B: SEM series of polymerized oil droplets containing FS particles. The particles are found at the interface, showcasing their ability to stabilize HDA/water interfaces.

FIG. 6: The hydrophilic and hydrophobic fumed silica particles are individually mixed into HDA, water, and ethanol, separately, to assess their dispersion behavior in each solvent. Hydrophilic LM-150 fumed silica particles can be dispersed in all diluents, while hydrophobic TS-610 fumed silica particles were dispersed in HDA and ethanol.

FIG. 7A: Ternary phase diagram of HDA, water, and ethanol. Precursors with compositions from points A through D in the miscible one-phase region are prepared, then quenched into the immiscible two-phase region via ambient evaporation of ethanol

FIG. 7B: Schematics describing CLSM sample preparation process.

FIG. 7C: CLSM of precursors A through D after quenching reveals a transition from oil-in-water emulsions (A) to water-in-oil emulsions (D) as the oil concentration increases, with bicontinuous structures formed near the transition critical point (B and C).

FIG. 8A: At low hydrophilic ratios (0.4), CLSM reveals water-in-oil emulsion structures and DEP is unable to permeate across the discrete pores.

FIG. 8B: For moderate hydrophilic ratios (0.7), CLSM reveals bicontinuous emulsion structures and DEP permeates across the continuous pores.

FIG. 8C: At high hydrophilic ratios (1.0), CLSM reveals oil-in-water emulsion structures and DEP weakly permeates across the continuous pores.

FIG. 9A: Size distribution of hydrophilic LM-150 particles dispersed in water (three data sets).

FIG. 9B: Size distributions of LM-150, TS-610 and a blend of particles dispersed in ethanol.

FIG. 9C: Size distributions of LM-150 and TS-610 dispersed in HAD

FIG. 10A: Surface SEM series of a 3D printed bicontinuous emulsion gel. The surface is covered with an polymer-particle crust due to drying of water before UV curing.

FIG. 10B: Surface SEM series of a 3D printed bicontinuous emulsion gel after removal of fumed silica particles. After etching, the bicontinuous polymer/pore microstructure is revealed.

FIG. 11: Permeation of DEP across a polymerized emulsion gel is monitored across an hour, as the porous 3D printed wall is visually monitored as it transitions from an opaque state to a transparent state. Rising of the DEP front indicates continuity of the 3D printed wall's pores.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise. Unless indicated to the contrary, the numerical values should be understood to include numerical values which are the same when reduced to the same number of significant figures and numerical values which differ from the stated value by less than the experimental error of conventional measurement technique of the type described in the present application to determine the value.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Bicontinuous emulsion gels are mixtures of inter-penetrating arrangements of two immiscible liquids stabilized with particles. The structures of such gels are readily made into simple macroscale geometries, like sheets and fibers; however, achieving more complex macroscopic structures while maintaining control over microscopic features and morphological bicontinuity remains a challenge. In this study, we demonstrate the ability to fabricate complex three-dimensional structures of bicontinuous emulsion gels using direct ink writing (DIW). The emulsion precursors are formulated with a mixture of hydrophilic and hydrophobic fumed silica particles; these precursors exhibit shear-thinning and yield stress behavior suitable for DIW. The thixotropic nature of the precursor further promotes the formation of bicontinuous emulsion gels through vaporization-induced phase separation and stabilization through both interfacial jamming and bulk stabilization mechanisms. This fabrication technique enables the creation of functional bicontinuous structures with complex architectures, pacing the way for application in biomedical implants, catalytic reactors and beyond.

Mixtures of dissimilar liquids, like oil and water, are inherently unstable, leading to complete phase separation in their equilibrium state. The addition of stabilizers into these mixtures enables the formation of kinetically trapped emulsion dispersions in a non-equilibrium state. When particles are used as stabilizers, two distinct classes of emulsions can be created: Pickering emulsions or bicontinuous emulsions. In the former, one phase forms discrete droplets dispersed in the other phase. In the latter, both phases are continuous and form an interpenetrating percolating liquid network throughout the emulsion gel. Bicontinuous emulsion gels possess certain properties, making them potentially useful in various applications. The bicontinuous configuration allows for independent transport of oil- or water-soluble species through their respective channels, while the high surface area of the interwoven phases promotes interfacial transport between them. Bicontinuous emulsion gels, with one aqueous and one organic domain, are classified based on their stabilization mechanism. Examples of these materials include bijels, stabilized by interfacial particle attachment and subsequent jamming, and bigels, stabilized through bulk nanoparticle jamming within the two phases. Attractive or repulsive particle networks have also shown to stabilize bicontinuous emulsion gels, in bipjel and SeedGel systems.

Various methods have been developed for the fabrication of bicontinuous emulsion gels. For example, bicontinuous emulsions are often produced using binary liquid mixtures with a critical solution temperature, such as a water-lutidine mixture. A temperature quench triggers phase separation through the critical point of the phase diagram, initiating spinodal phase separation and generating a bicontinuous morphology. Bijels, bipjels, and SeedGels have been fabricated using this technique; the stabilization mechanisms across emulsion types depend on the particle chemistry. For bijels, complementary approaches exploit a single phase, ternary mixture of co-solvent, organic and aqueous components. Removal of co-solvent near the system's critical point initiates spinodal decomposition, leading to the formation of bijels that are stabilized through the interfacial attachment and jamming of neutrally wetting particles. Co-solvent removal can be achieved either by mass transfer into an external aqueous phase, triggering solvent-transfer induced phase separation (STRIPS), or by vaporization into the surrounding gas phase, leading to vaporization-induced phase separation (VIPS). Bicontinuous structures in the form of bigels and bijels can be fabricated by directly mixing two immiscible liquids.

Applications of bicontinuous emulsions exploit enhanced transport properties made possible by their structure. For example, bijels with their interfacially jammed particle layer, have shown promise in applications in reactive separations and liquid-liquid extraction. Bigels have been explored for applications in food science and cosmetics. Moreover, to capitalize on the bicontinuous structure of these systems, highly porous materials with interconnected polymeric and pore phases have been formed by crosslinking one of the two liquid phases. Such bicontinuous materials have been developed for applications such as ultrafiltration, passive daytime radiative cooling coatings, energy storage devices and hydrogels for cell delivery systems.

The functionality of bicontinuous emulsions depends heavily on their macroscopic geometry as well as their internal microstructures. Current fabrication techniques restrict production of bicontinuous emulsion gels to relatively simple morphologies. Thermally quenched structures are typically limited by the shape of their container and temperature gradients. STRIPS and VIPS methods facilitate continuous manufacturing of bicontinuous emulsion gels and have been used to create bijels with a range of morphologies, such as particles, fibers, thin films, ropes, and other complex two-dimensional planar structures.

Three-dimensional (3D) printing is a promising approach to create bicontinuous emulsion gels with more complex designs, allowing for advanced integration of bicontinuous structures into engineering systems. Direct ink writing (DIW) is a widely used 3D printing method in which the material, or “ink”, is extruded layer-by-layer onto a substrate until the desired structure is formed. DIW is particularly well-suited for bicontinuous gel fabrication because it is compatible with a wide range of inks, including colloidal gels and emulsions. his versatility makes DIW an excellent method for creating bicontinuous emulsion gels with complex three-dimensional geometries, opening new possibilities for their applications.

Previous efforts to create bicontinuous hierarchical materials via extrusion-based 3D printing have achieved varying degrees of success. Bicontinuous emulsion gels produced by direct mixing have enabled the development of diverse 3D structures such as cubic lattices with functional properties such as high electrical conductivity. However, phase-separation-based bicontinuous emulsion gels provide distinct advantages. The formation of the bicontinuous morphology, particularly at the sub-micrometer scale, does not require energy-intensive mixing prior to extrusion, making this approach more suitable for scalable manufacturing. Moreover, the morphology and the domain size can be controlled by adjusting ambient factors such as relative humidity or solvent removal rate, ensuring reproducibility across operators and equipment. While STRIPS bijels produced through liquid-in-liquid printing have confirmed bicontinuous microstructures, their higher density relative to the surrounding bath restricts their macroscale geometries to 2D planes.

In this work, we present a technique to fabricate three dimensional, VIPS-based bicontinuous nanoparticle-stabilized emulsion gels via DIW. We design a printable one-phase precursor ink which spontaneously phase separates into a two-phase bicontinuous emulsion gel after extrusion via ambient co-solvent evaporation. Inspired by prior work that demonstrated the stabilization of various multiphasic mixtures, we introduce mixtures of hydrophilic and hydrophobic fumed silica into the emulsion precursor to modify its rheology and stabilize the bicontinuous structure. We demonstrate the effectiveness of this approach by fabricating bicontinuous emulsion gels with complex 3D morphologies and identifying the rheological characteristics of the successful precursor ink. Additionally, we explore how variations in the precursor composition influence the resulting structure at the submicrometer scale. This printing method enables the continuous fabrication of bicontinuous nanoparticle-stabilized emulsions with hierarchical and complex 3D geometries. This ability to control the shape of bicontinuous structures is useful for applications in biomedical systems, biphasic catalytic reactions, heat exchangers, filtration systems, and more.

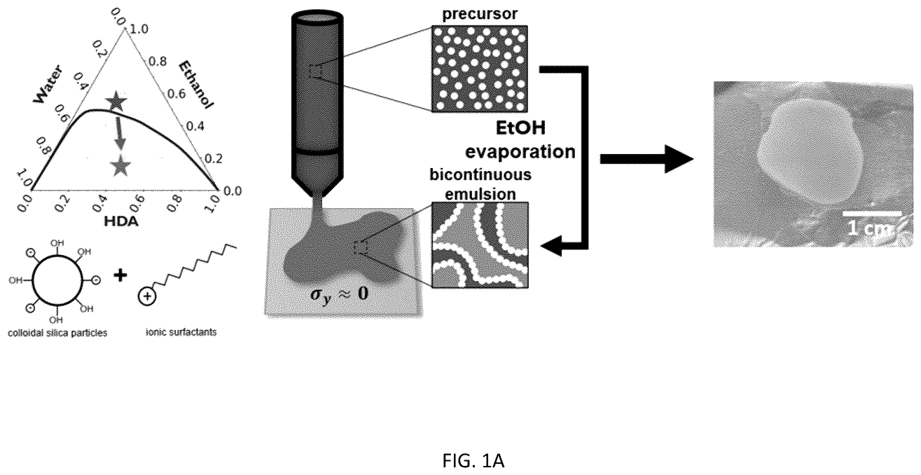

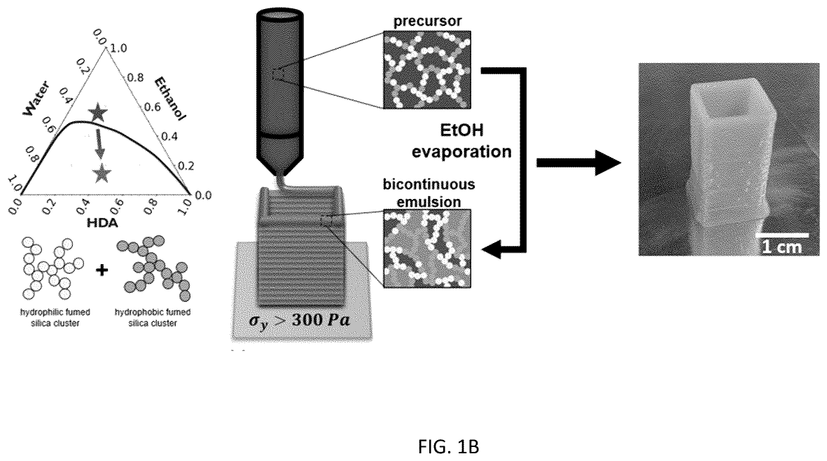

We use vaporization-induced phase separation (VIPS) to produce bicontinuous emulsion gels due to this method's simplicity and versatility. Bicontinuous emulsion 3D printing via VIPS, however, entails departure from the conventional VIPS bijel precursor suspension which typically consists of an oil-water-solvent ternary mixture, colloidal silica particles, and surfactants. These conventional precursors spread on the substrate and are unable to support vertical layering of material due to their fluid-like behavior. As such, the conventional VIPS bijel precursor is incompatible with 3D printing as shown in FIG. 1A. We modify the conventional VIPS bijel precursor to enable 3D DIW. Rather than using colloidal silica nanoparticles with surfactants, we use fumed silica particles to support 3D structures as depicted in FIG. 1B. These fumed silica particles provide structural stability through both interfacial jamming and bulk stabilization; this latter mechanism confers the rheological characteristics suitable to support three dimensional structures during printing.

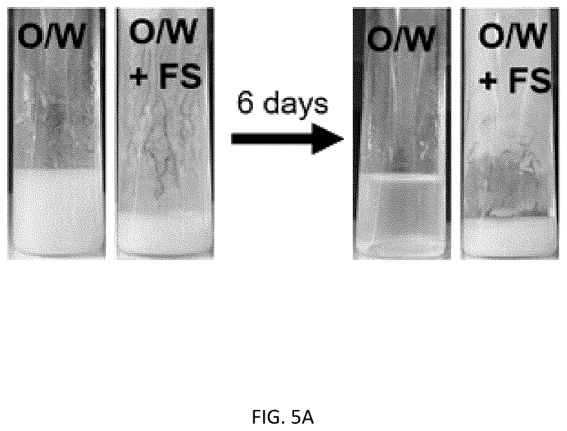

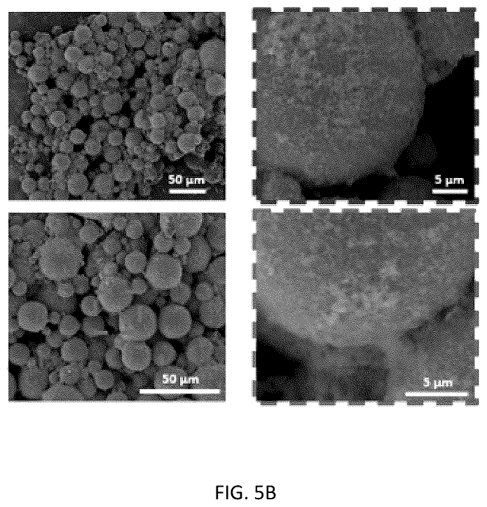

The materials used to create the printable emulsion precursor include 1,6-hexanediol diacrylate (HDA) as oil, water at a pH of 3 as an aqueous phase, ethanol as a co-solvent, CAB-O-SIL LM-150 hydrophilic fumed silica particles, CAB-O-SIL TS-610 hydrophobic fumed silica particles, and 2-hydroxy-2-methylpropiophenone (HMP) as a photoinitiator. The oil HDA is chosen since it can be polymerized via UV curing in the presence of the photoinitatior HMP. Photopolymerization facilitates structural characterization via confocal laser scanning microscopy (CLSM) and scanning electron microscopy (SEM). Ethanol is an appropriate co-solvent due to its high volatility and its ability to form a solution with water and HDA. The pH of the water is adjusted to 3, as the surface chemistry of silica and its wetting behavior are highly dependent on the pH. We select these two variants of fumed silica particles because they attach well to the HDA-water interface (see FIG. 5). It should be understood that the exemplary systems and compositions described herein are exemplary only and do not limit the scope of the present disclosure or the appended claims.

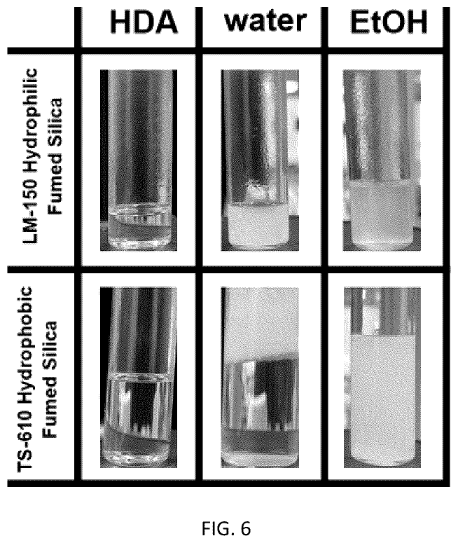

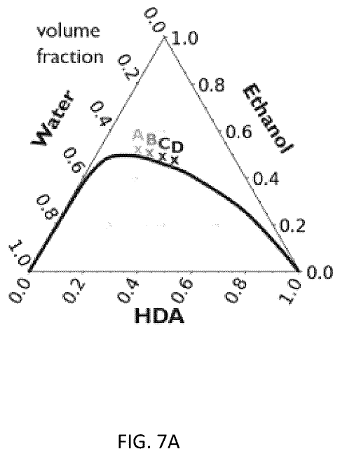

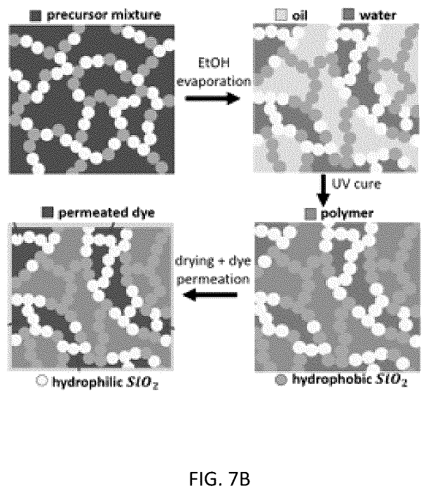

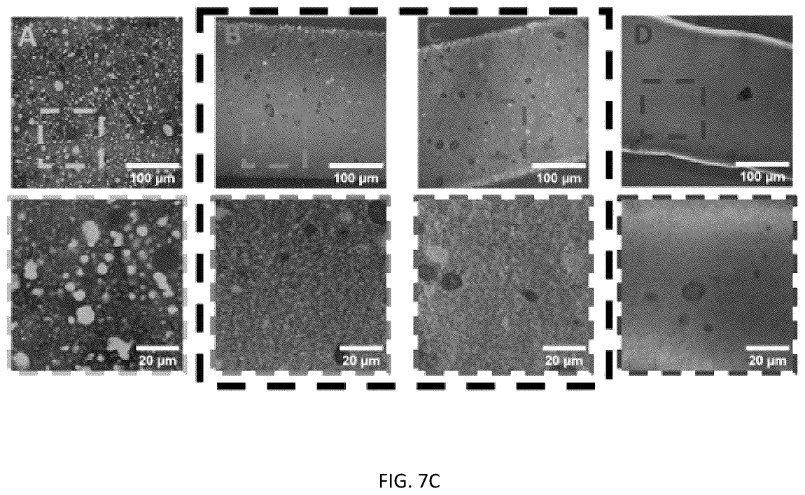

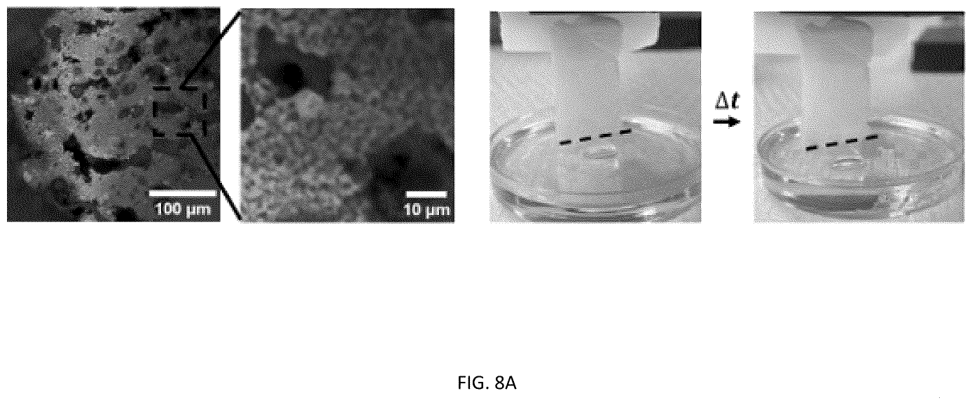

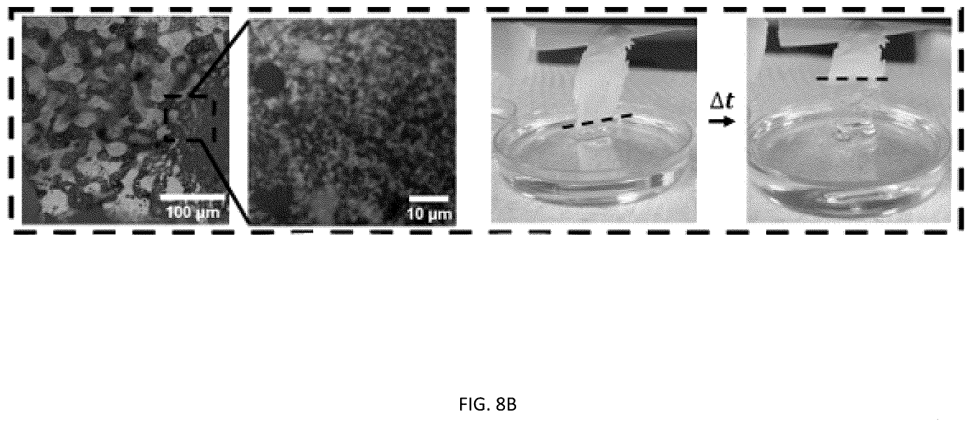

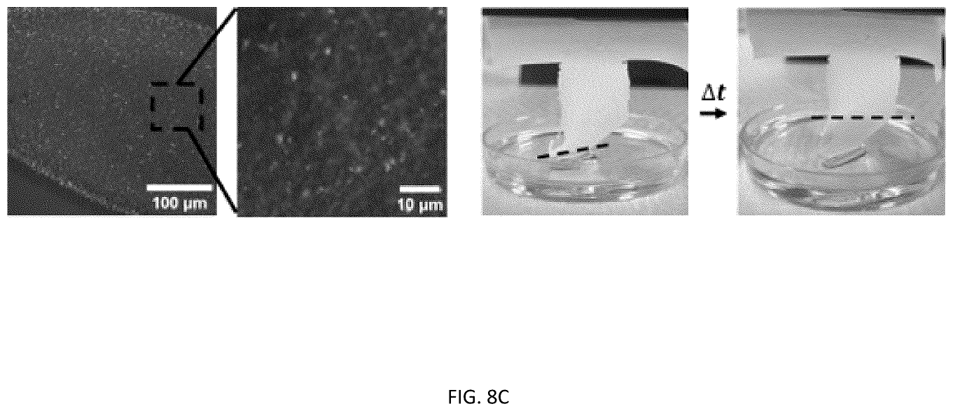

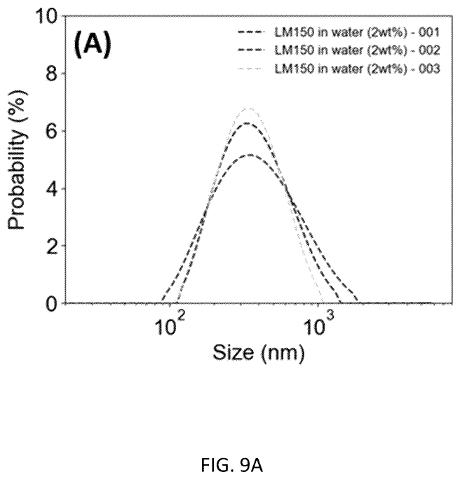

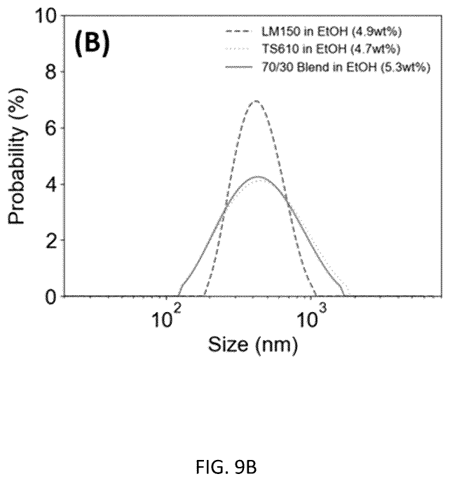

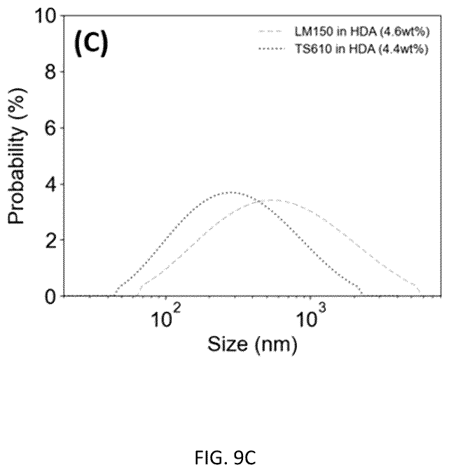

The wetting behavior of the two fumed silica particles differs substantially; the hydrophilic variant can be dispersed in both water and HDA, whereas the hydrophobic fumed silica particles were suspended in HDA (see FIG. 6). The composition of the precursor ink is designed to satisfy two conditions: the oil-to-water ratio should be near the critical point of the phase diagram to promote bicontinuous phase generation upon ethanol removal, and the ratio of hydrophilic-to-hydrophobic fumed silica should promote formation of neutrally wetting silica clusters. Briefly, the ternary phase diagram is established, the critical point along the binodal line is located to promote bicontinuous emulsion formation (FIG. 7 and Table 1), and a neutrally wetting particle ratio is identified to facilitate interfacial stabilization (FIG. 8). Here, we also note the tendency of fumed silica to form fractal-like clusters and aggregates, with sizes ranging from 300-400 nm (FIG. 9).

### Fumed Silica Particles Enable 3D Printing Through Precursor Gelation

To formulate an emulsion precursor that is DIW-compatible, we investigate the effect of hydrophilic and hydrophobic fumed silica particles on the rheological properties of the ternary liquid mixture. Ideal inks for DIW 3D printing tend to be shear-thinning materials with yield-stress behavior, enabling shape retention after extrusion and the ability to add layers on top of each other. In a yield stress fluid, if stress is applied above a threshold, flow will be induced. If an ink's yield stress, storage modulus, and viscosity are inadequate, the ink is not “printable” and spreads on the substrate. Such inks cannot support vertical layering, resulting in poor shape retention.

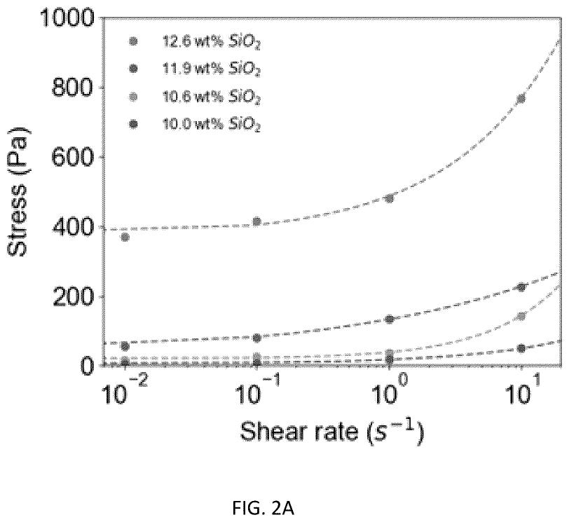

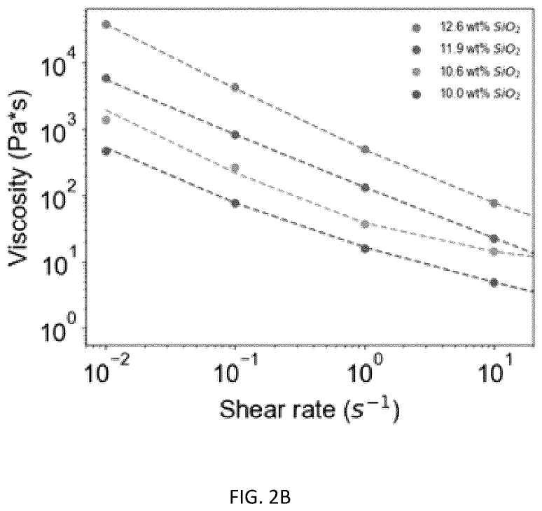

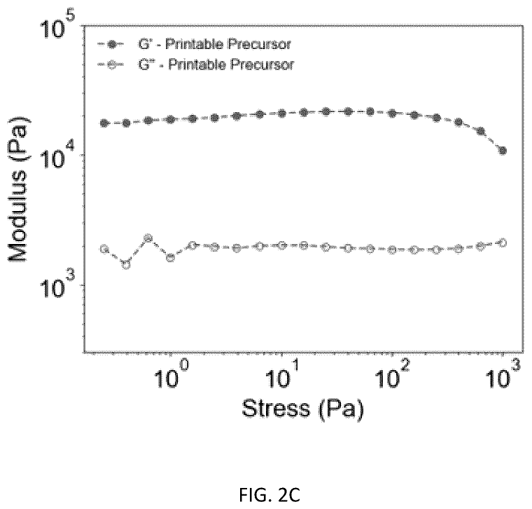

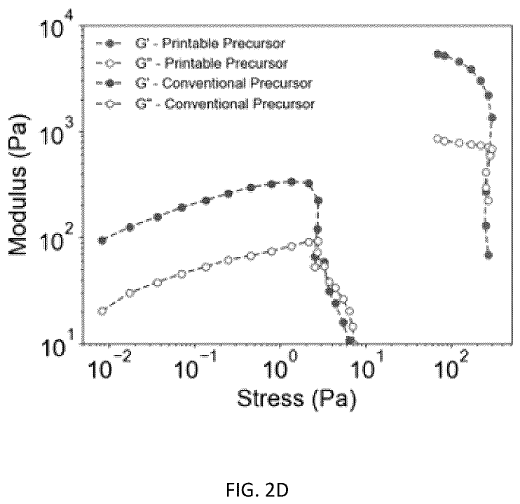

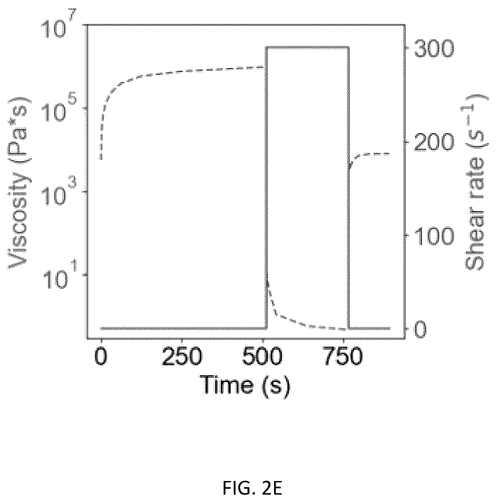

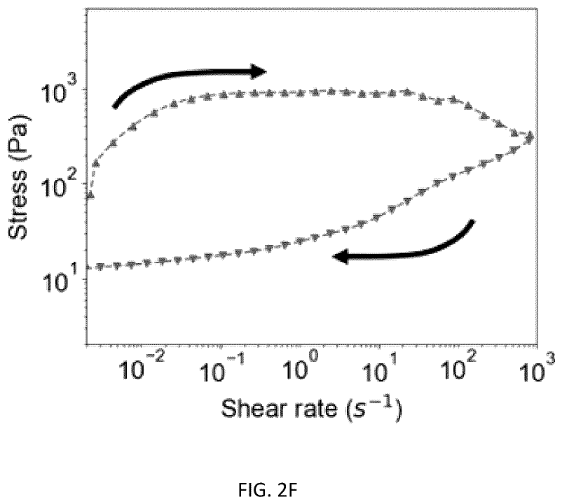

To determine the particle content to impart these characteristics to the printable emulsion precursor, we perform flow-sweep rheology of precursors with increasing particle loadings. For silica loadings, stress increases as shear rate increases with non-Newtonian behavior as shown in FIG. 2A. The flow sweep data is fit to the Hershel-Bulkley fluid model; the model parameters are summarized in Table 2 for each silica loading. The yield stress, which can be inferred from the y-intercept of FIG. 2A, increases with particle loading. The data also indicate shear-thinning behavior, as the Hershel-Bulkley flow parameter is found to be below unity for each of the silica loadings. For reference, in this model, a flow parameter equal to one implies Newtonian behavior, whereas a value greater than one implies shear-thickening behavior, and a value less than one implies shear-thinning behavior. Viscosity decreases as shear rate increases for silica loadings, indicating shear-thinning behavior as seen in FIG. 2B. The viscosity of the precursor increases with the loading of fumed silica. The precursor with a silica loading of 12.5 wt % is of particular interest for further analysis.

Small amplitude oscillatory shear (SAOS) rheology of the emulsion precursor is shown, where the precursor's storage (G′) and loss (G″) moduli are measured in response to an increasing deformation amplitude with a fixed frequency of 2π Hz. As amplitude increases, the deformation stress response of the precursor increases, influencing the moduli. In the SAOS regime established in FIG. 2C, the precursor exhibits solid-like or gel-like behavior, indicated by the storage modulus exceeding the loss modulus by an order of magnitude, along with a strong linear viscoelastic region (LVR) plateau. As amplitude increases further beyond the LVR in FIG. 2D, the precursor undergoes a gel-to-fluid transition, as indicated by the loss modulus overtaking the storage modulus. This transition point where G″ surpasses G′ is another method to measure yield stress. This experiment reveals a precursor ink yield stress on the order of 300 Pa, which agrees with the value found previously from fitting flow sweep data to the Hershel-Bulkley model.

We also compare the behavior of the 3D-printable fumed silica-based emulsion gel precursor to that of the conventional colloidal silica-based VIPS bijel precursor. The conventional bijel precursor has negligible yield stress and a weak storage modulus in the LVR, over an order of magnitude less than that of the 3D-printable fumed silica system. The conventional bijel precursor is unable to support 3D printing because its negligible yield stress cannot support layering of material, and its shape retention is poor due to its low storage modulus. Meanwhile, the fumed silica-based precursor ink supports 3D printing due to the enhanced yield stress and storage modulus attributed to precursor gelation. With a yield stress on the order of 300 Pa and a storage modulus on the order of 104 Pa in the SAOS regime, the rheological profile of the bicontinuous emulsion precursor ink is comparable to other extrusion-based 3D-printable multiphasic (but non-bicontinuous) emulsion inks, where printability is established with a yield stress above 200 Pa or with a product of yield stress and storage modulus greater than 5×106 Pa2.

We characterize the transient thixotropic response of the precursor to simulate conditions experienced during 3D printing, as shown in FIG. 2E. In the first step, the 12.5 wt % precursor is exposed to a low shear rate of 0.01 s-1 for an extended period to simulate “in-barrel” behavior, as if the precursor was slowly moving down the wider portion of the printer's syringe before extrusion. In this regime, the precursor has a large viscosity, as the applied shear rate is too weak to disrupt the precursor's gel network. Thereafter, the shear rate is rapidly increased to 300 s-1, to simulate conditions experienced by the material as it is extruded through the deposition nozzle. Lastly, the shear rate is rapidly decreased to 0.01 s-1 for the remainder of the experiment; this regime is designed to simulate post-extrusion conditions, where the ink resists gravitational stresses to retain its structure. Upon cessation of shear, the precursor's viscosity recovers within 40-60 seconds; this recovery is due to the thixotropic behavior of the precursor which is useful to prevent spreading after extrusion and helps to maintain print fidelity. However, viscosity does not recover to its pre-extrusion value; the precursor's particle gel is disrupted during extrusion but is unable to recover to its original state post-extrusion. The thixotropic behavior of the precursor is also verified through a hysteresis loop, displayed in FIG. 2F. In the hysteresis loop, stress is measured as shear rate increases during the ramp-up curve and as shear rate decreases during the ramp-down curve. The printable precursor supports higher stresses during the up-curve, relative to the down-curve. This behavior is typical of a thixotropic material, as there is a loss in viscosity during high-shear exposures. While the relationship between rheological changes and microstructural changes is not fully understood, the precursor ink's reduction in viscosity in high-shear environments is tied to changes in the precursor's fumed silica gel network, which gradually recovers when the high shear is removed. At high shear rates, the structure of this gel network is disrupted and does not recover fully, as reported in FIG. 2E.

The timescale for the recovery of gel-like behavior likely plays a role in the formation of the bicontinuous microstructure after DIW. Based on our prior work, it takes ~tens of seconds for bijel morphology to develop in VIPS using the colloidal silica-based precursor, so these two processes are likely to occur simultaneously. The consequences of these two processes are discussed further when characterizing the microstructure of the quenched bicontinuous emulsions.

### 3D Printed Bicontinuous Emulsion Gels Feature Submicrometer-Sized Domains

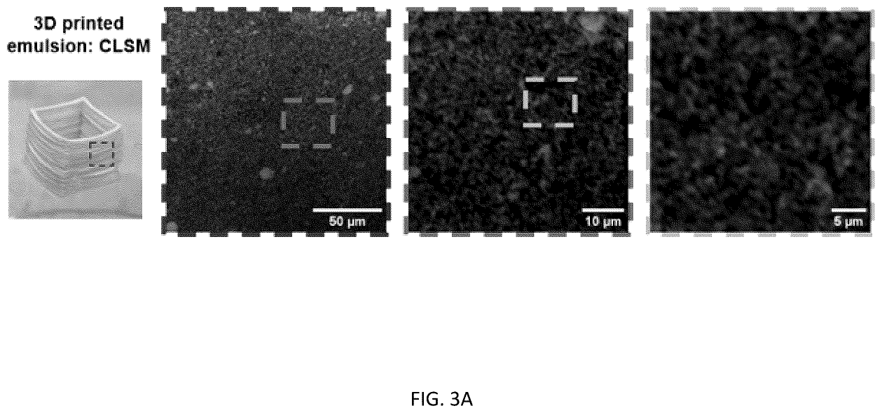

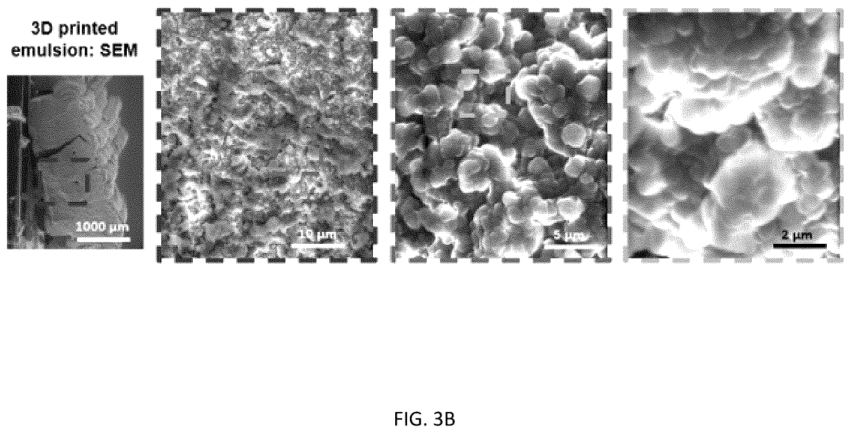

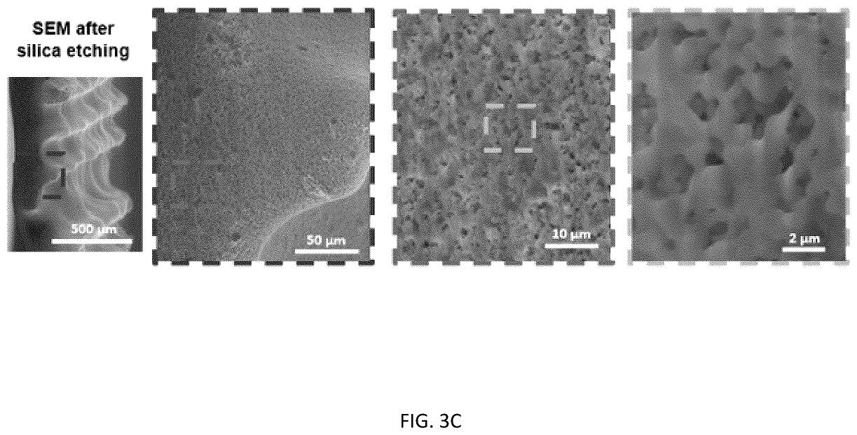

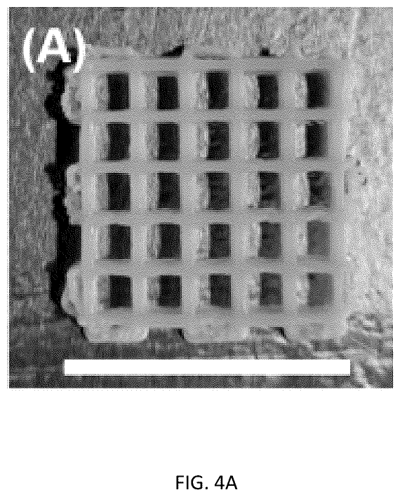

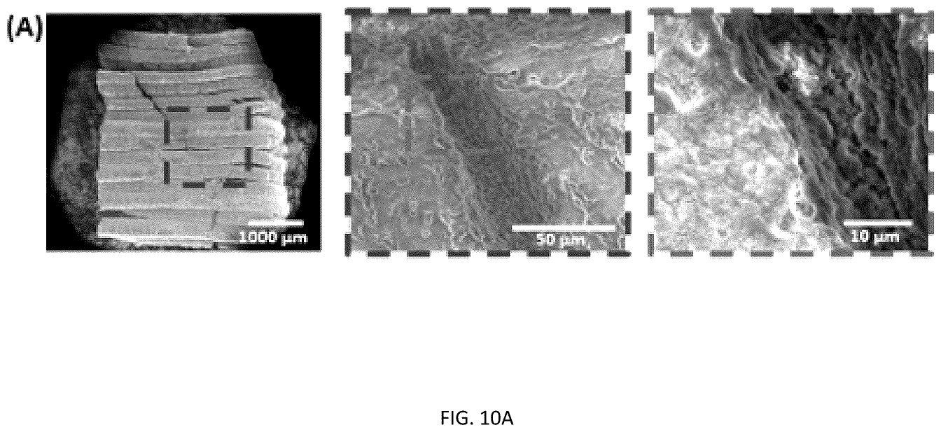

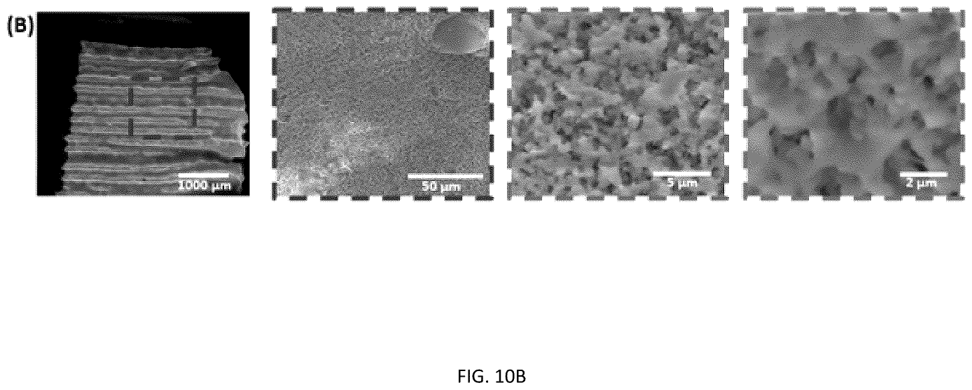

To confirm that 3D printed structures have a bicontinuous morphology, we analyze their microstructure using CLSM and SEM. We print a 3D rectangular prism with the dimensions of 1 cm×1 cm×1 cm, consisting of 40 layers of filaments with a diameter of 250 μm. The structure is crosslinked under UV irradiation after 2 minutes of ethanol evaporation. A wall is cut from the prism and viewed under CLSM. The green structures represent the fluorescent signals from the Nile red containing polymer and correspond to the oil phase of the structure. Black represents the pores formerly occupied by water. Under high magnification, the bicontinuous microstructure is revealed on length scales ranging from hundreds of nanometers to micrometers as shown in FIG. 3A. To have a clearer visualization of sub-micrometer structures, we perform cross-sectional SEM on fractured samples. Fumed silica clusters on the order of hundreds of nanometers obscure the underlying morphology as seen in FIG. 3B. These particles are located at the polymer-pore interface, indicating that they were either interfacially jammed before UV curing or were particles suspended in the aqueous phase that settled on the polymer surface after the water was removed. To reveal the porous microstructure more clearly, these silica particles are removed before SEM imaging via dissolution in a 1M NaOH solution overnight. Without silica particles, the bicontinuous and porous nature of the 3D printed material is revealed clearly as shown in FIG. 3C. The sizes of the polymer and pores are on the order of hundreds of nanometers to micrometers and appear similar to what is observed under CLSM. Additionally, the surface of the printed emulsion gels is characterized via SEM in FIG. 10, revealing similar structures found in the cross-sectional analysis.

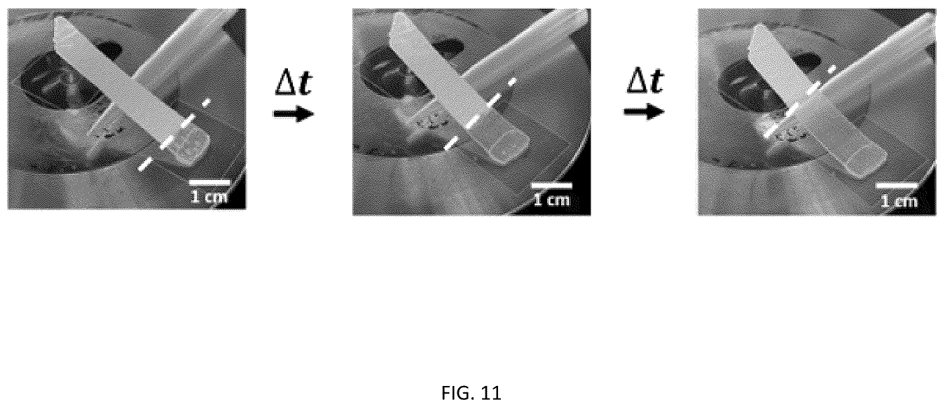

Furthermore, the SEM characterization indicates the microstructures are uniformly sized throughout the 3D printed monoliths, both internally and on the surface. The structures even extend across adjacent printed layers, suggesting bicontinuity may be established across the structure. We confirm the bicontinuous morphology across 3D printed layers by inducing capillary infiltration across the pores of these structures, as demonstrated in FIG. 11. We believe the structural uniformity forms during the printing process. As new filament with a high concentration of ethanol is extruded onto an existing structure, the cosolvent diffuses into layers beneath, decreasing the interfacial tension between printed layers and allowing for continuous microstructures across layers to merge together.

Notably, the microstructures of these 3D printed bicontinuous emulsions have features that differ from those observed in bijels prepared using spinodal-based techniques that are based on ternary mixtures, such as VIPS or STRIPS. Bijels formed via spinodal pathways are identified through their zero mean curvature and negative Gaussian curvature along the oil-water interface. Solvent transfer-based bicontinuous emulsions typically form domain sizes on the order of tens of micrometers.^{5,6} Recent reports have shown that submicrometer-sized domains can be stabilized by regulating the mass transfer kinetics for solvent removal or modifying the particle surface chemistry through surfactant or covalent functionalization. Remarkably, 3D printed bicontinuous emulsions also have stable submicrometer domains, without implementing any additional regulation of co-solvent removal dynamics or particle functionalization. This finding suggests that another structural stability-enhancing mechanism may be playing a role that is not present in typical solvent removal-based bicontinuous systems.

To explore this premise, we consider the complexity of the 3D printable system, as the quenched microstructure is influenced by a variety of factors. The rheology of the precursor ink implies that gel-like structures form before the system phase separates. There are two types of particles in the system that both tend to form rough, fractal-like aggregates and clusters, which likely behave differently at the interface when compared to spherical particles. Moreover, the thixotropic nature of the system supports the recovery of gel-like structures in both the aqueous and the oil phases after they are weakened during high shear extrusion.

Considering the structural difference between the 3D printed bicontinuous emulsions and the conventional VIPS-based system,⁶ it is possible that these 3D printed microstructures form through a non-spinodal pathway. Bicontinuous emulsions fabricated through non-spinodal paths have been previously reported. For example, VIPS bijels were formed through a partial coalescence mechanism, where a percolating network forms through nucleation and growth of many droplets that bridge together due to incomplete interfacial particle assembly. Further, bijels and bigels can be formed via direct mixing of two immiscible fluids. As such, spinodal decomposition is not a requirement for bicontinuous emulsions production. Given the lack of distinct spinodal-like structures in the 3D printed bijel system, despite optimizing the ternary liquid mixture around its critical point, questions arise surrounding the stabilization mechanism of these VIPS generated structures. In particular, the relative importance of interfacial jamming or other mechanisms such as bulk stabilization is worthy of discussion.

The interfacial activity of the fumed silica particles, as shown in FIG. 5, suggests that the 3D printed bicontinuous emulsions are stabilized, at least in part, through interfacial attachment and jamming of adsorbed particles. However, due to the high fraction of particles present in the system, and the complex rheology of these suspensions, we infer that particles form structures within both the HDA and water phases. Upon extrusion, bulk phase gelation is diminished as shown in FIG. 2, and fumed silica can undergo rearrangements and sample the local environment via diffusion. These factors may promote particle reorientation and adsorption to the HDA/water interface to facilitate interfacial jamming as phase separation generates the interface with surface tension that is large enough to trap particles. Concomitantly, recalling that gel recovery and VIPS phase separation operate on similar time scales of tens of seconds, particles dispersed within both the HDA and water phases likely form percolating particle networks within the bicontinuous HDA and water phases. These gelation mechanisms, we believe, hinder coarsening and coalescence of the bicontinuous emulsions, allowing for stabilization of bicontinuous emulsions with submicrometer-sized domains. These two mechanisms operate simultaneously and have been shown to provide a synergistic effect to enhance elastic behavior in Pickering emulsion systems. Therefore, we believe both interfacial jamming and bulk stabilization mechanisms contribute to the stabilization of these submicrometer-sized bicontinuous emulsion gels.

DIW Allows for Emulsion Fabrication with Complex Geometries

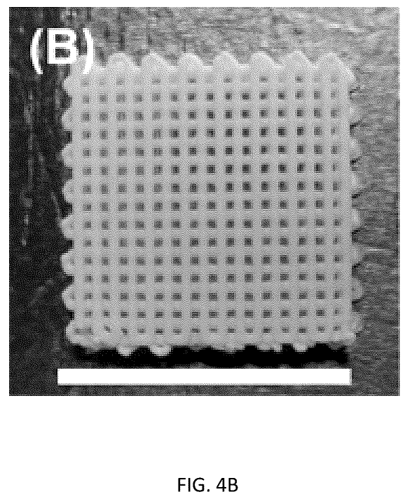

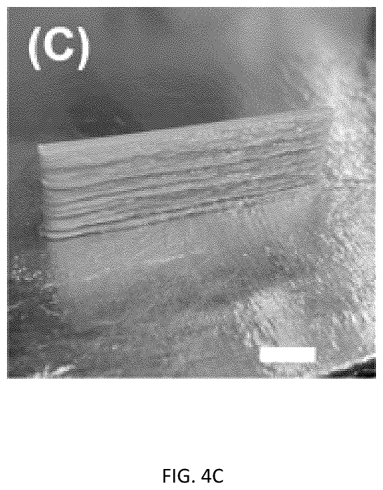

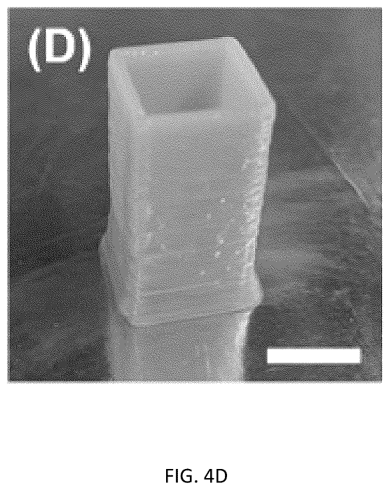

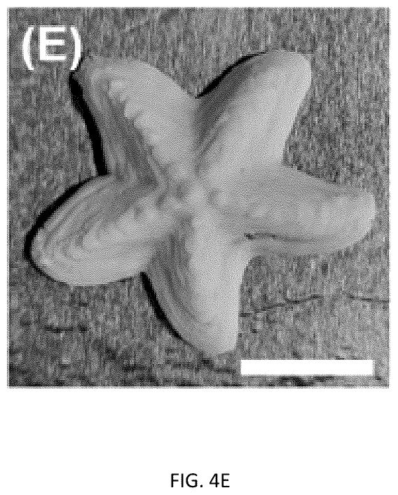

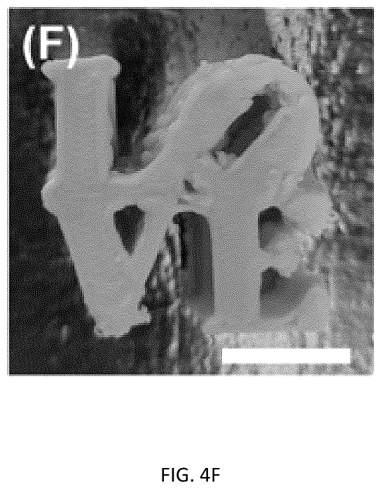

Using our bicontinuous emulsion gel precursor ink, we print designs of varying complexity, such as a starfish and Philadelphia LOVE sculpture, using a 250 μm nozzle at a printing speed of 15 mm/s as shown in FIG. 4. Print fidelity is influenced by ink properties, such as yield stress and surface adhesion, and the printing parameters, such as extrusion pressure, nozzle diameter, and print speed. We optimize printing parameters to prevent print failure; if filament gaps are formed (under-extrusion), the extrusion pressure is increased or the print speed is decreased. If filament globs are formed (over-extrusion), the extrusion pressure is decreased or the print speed is increased. To print high resolution structures, one can begin with a small-diameter nozzle and increase the size based on performance, as smaller nozzles are prone to clogging. Additionally, opaque barrels and nozzle tips are used to prevent nozzle clogging due to premature ambient UV polymerization. Our results clearly demonstrate that this 3D printing technique can be used to produce bicontinuous emulsions with complex, hierarchical geometries in a scalable manner. This is particularly useful when creating porous materials with sub-micrometer domains, which are of interest for electrodes for energy storage, membrane separations, bioscaffolding, bioengineering, and other domains. Further, we anticipate that print fidelity can be improved further with more advanced DIW configurations including implementation of layer-by-layer or partial UV curing, employing sacrificial scaffolding materials, or through humidity control of the printing chamber.

In summary, we have developed a method to 3D print bicontinuous emulsion gels using DIW. By 3D printing these nanoparticle-stabilized structures, this technique allows for the continuous fabrication of hierarchical porous materials with complex and user-customizable geometries. We realize 3D printing by introducing mixtures of hydrophilic and hydrophobic fumed silica into the ternary liquid oil/water/co-solvent emulsion gel precursor. Fumed silica particles induce particle gelation in the precursor, significantly altering the precursor's rheological properties to meet DIW suitability. The rheological characterization of the precursor reveals a sufficient yield stress and strong storage modulus in the low stress LVR, supporting material layering during extrusion and promoting shape retention after extrusion. Once printed, bicontinuous emulsion formation progresses through ambient vaporization induced phase separation. By UV curing the printed emulsion and drying to remove excess liquid, we create a hierarchical porous material. Characterization via CLSM and SEM imaging shows that the 3D printed bicontinuous emulsions possess sub-micrometer domains. We propose that these emulsions are stabilized by two mechanisms that occur simultaneously. The DIW ink, whose network is weakened by high shear during printing, allows particle clusters to adsorb and jam along the interface during phase separation. At the same time, particle clusters in each domain re-form gels and stabilize the bicontinuous morphology via the formation of percolating phase-spanning networks. These findings are supported by comparison of the thixotropic gel recovery timescale and the VIPS bijel formation timescale, which are both on the order of tens of seconds. These mechanisms are enhanced due to volume reduction effects as ethanol evaporates from the system, further increasing surface tension and particle concentration, providing greater jamming along the interface and within each domain, respectively. We demonstrate DIW capabilities through printing 3D structures of various levels of complexity. As hierarchical, biphasic, particle-stabilized, and surfactant-free materials, these 3D printed bicontinuous emulsions can be functionalized for a diverse array of applications, including electrodes for energy storage, bioscaffolds for cell growth, biomedical systems, heat exchangers, and chemical reactors.

### Methods/Experimental Procedures

### Materials

The emulsion precursor ternary mixture consists of 1,6-hexanediol diacrylate (HDA, 99%, Sigma), water, ethanol (200 proof, Decon Laboratories, Inc.). The water in the ternary mixture is adjusted to a pH of 3 using a 1M solution of HCl (Fisher Chemical). Hydrophilic fumed silica particles (CAB-O-SIL LM-150) and hydrophobic fumed silica particles (CAB-O-SIL TS-610) are provided by Cabot Corporation. For UV curing polymerization, 2-hydroxy 2-methylpropiophenone (HMP, 97%, Sigma) is added into the mixture. For fluorescence imaging via CLSM, Nile Red (microscopy grade, Sigma) and 9,10-bis(phenylethynyl) anthracene (BPA, 97%, Sigma) are used as fluorophores to image the two emulsion phases. For permeation experiments, polymerized emulsions are submersed in diethyl phthalate (DEP, 99.5%, Sigma).

### Bicontinuous Emulsion Gel Precursor Ink Preparation

The components of the 3D printable precursor are: (1) HDA, (2) water, (3) ethanol, (4) hydrophilic fumed silica, (5) hydrophobic fumed silica, and (6) HMP. To form a typical printable precursor, these components are mixed with the following ratios of components and in the listed order: (1) 3.82 g, (2) 4.28 g, (3) 5.79 g, (4) 1.60 g, (5) 0.72 g, and (6) 0.35 g. The mixture is shaken after ethanol is added to the mixture to form a miscible ternary solution. After the hydrophilic fumed silica particles are added, the mixture is shaken and vortexed until visually large agglomerates of silica are dispersed. Then the hydrophobic fumed silica particles are added to the mixture and the mixture is vortexed and then sonicated for 45-60 minutes. The mixture is stored in the dark to prevent any ambient UV polymerization. The precursor is sonicated for 45-60 minutes before experiment and 3D printing to reduce aggregation of silica particles.

### 3D Printing Protocol

Prior to printing, the precursor ink is transferred to an opaque black 10 cc syringe barrel (Nordson). The barrel is fitted with a 25 G opaque rigid dispensing tip (Nordson) with an inner diameter of 250 μm. Opaque components are selected to prevent premature polymerization of the bicontinuous emulsion due to ambient UV exposure, which would obstruct the nozzle tips and inhibit extrusion. Samples are printed via a MakerGear M2 3D Printer modified with a pneumatic control apparatus for compatibility with a wide range of inks at room temperature. The build plate is a MakerGear borosilicate glass build surface coated with Bytac, a laminate composed of FEP and aluminum. Printing speed and applied pressure are adjusted until the ink maintains filament fidelity. After extrusion, the printed structures undergo polymerization via UV irradiation (320-500 nm, 40 W/cm²). To demonstrate printability, 1 cm×1 cm woodpile-structured scaffolds with span factors of 1 and 4 were printed, as well as a 75-layer wall, a 100-layer hollow rectangular prism, a 1:100 replica of the Philadelphia LOVE sculpture, and a starfish.

### Rheological Characterization

A TA Instrument DHR-3 rheometer is employed with a 40 mm cone-plate geometry. A solvent trap is installed to address the effects of ethanol evaporation on rheology measurements of the emulsion precursor. For measurements, temperature control is implemented and set to 25° C. For flow-sweep experiments, stress and viscosity are measured at shear rates of 0.01, 0.1, 1.0, and 10 s-1. The stress vs. shear rate data is fit to the Hershel-Bulkley model to determine the yield stress. For oscillatory amplitude-sweep experiments, the storage (G′) and loss (G″) moduli are measured for increasing amplitudes, with a constant frequency of 2π. To assess thixotropy of the precursor, viscosity is measured transiently, with stepwise shear rates of 0.01, then 300, then 0.01 10 s-1. Thixotropy is also tested via hysteresis loop, where stress is measured as shear rate increases then subsequently decreases.

### Confocal Laser Scanning Microscopy Characterization

To enable fluorescence imaging of emulsion structures, a trace amount of Nile red is mixed into the precursor after components are mixed. Nile red is a hydrophobic fluorophore and selectively partitions into the emulsion's oil phase during phase separation via ethanol evaporation. After UV-induced polymerization of the HDA phase and drying of the water phase, Nile red remains inside of the polymer phase, and as a result, an Olympus FV1000 confocal laser scanning microscope is used to image the polymerized emulsions. Polymerized emulsions are immersed in DEP, which permeates into the pores of the polymerized emulsion. To image the pore phase, trace amount of BPA is added to DEP, which is a second fluorophore. The polymerized emulsion is immersed in DEP for at least 10 minutes before imaging under confocal microscopy. A 488 nm laser is chosen for fluorescence excitation. Two separate emission channels are monitored to image the polymerized emulsion: 490-520 nm to image the pore phase (BPA emission) and 560-660 nm to image the polymer phase (Nile red emission). Each image is acquired at 512×512 pixels with a scan rate of 200 μs/pixel. The images are processed in ImageJ for false coloring.

### Scanning Electron Microscopy Characterization

A FEI Quanta 600 FEG Mark II SEM is employed for imaging of 3D printed bicontinuous emulsions after UV curing and drying. The instrument is operated under high vacuum at a pressure of 0.38 torr. Images are acquired by applying a 5-10 kV electron beam along with a spot size of 3.0. Images are taken across a length of magnifications, ranging from 50× to 70000×. 4 nm Ir is sputter-coated on to the viewing surface, to reduce surface charging from silica particles.

### Interfacial Activity of Fumed Silica Particle Mixture

We test the ability of the two fumed silica particles to assemble and stabilize HDA/water interfaces. We form oil-in-water emulsions of HDA droplets in water by mixing at 10,000 rpm for two minutes, with and without fumed silica (FS). If the two particles are present in the mixture, the emulsion remains stable for at least a week, whereas the emulsion destabilizes rapidly with evidence of macroscale phase separation within 120 minutes if particles are not present. This implies the presence particles at the interface. These HDA droplets are polymerized via UV curing to allow for SEM imaging, where clusters of fumed silica are seen on the surface of these polymerized droplets further supporting the interfacial assembly of the two fumed silica particles.

### Dispersibility of Fumed Silica Particles

The fumed silica particles are used as received by the manufacturer. They are classified as “hydrophobic” and “hydrophilic” but their miscibility with the HDA, water, and ethanol is unknown. To confirm their dispersibility in these solvents, low concentration mixtures of particles are formed. We prepare mixtures the hydrophilic and hydrophobic particles at 2 wt % in each of the three solvents, and their dispersibility is assessed via inspection. Both particle variants can be mixed in HDA, forming a transparent dispersion. In water, the hydrophobic variant is immiscible; the hydrophilic variant is miscible and forms a cloudy dispersion. Both variants can be dispersed in ethanol, also forming an opaque dispersion.

### Ternary Phase Diagram Construction and Critical Point Determination

The critical point is found by comparing quenched emulsion structures from precursors with compositions just outside the binodal regime. However, to do this, the binodal line must be constructed. The binodal line is mapped by measuring the amount of ethanol used to create a miscible system for various ratios of HDA to water. Equal amounts (1.00 g) of water and HDA are added to a glass vial. Ethanol is added dropwise into the vial, while gently stirring the mixture between subsequent additions of ethanol, and the phase behavior is observed. If the mixture visually appears turbid and cloudy, the system is in an immiscible two-phase state. With enough added ethanol, the system transitions to a visually transparent, miscible one-phase state. The amount of added ethanol to produce this turbid to transparent is recorded to tabulate the first data point of the binodal curve. Then, the amount of water in the solution is increased by 5% to create a turbid immiscible two-phase system and this added water mass is recorded. Ethanol is added dropwise again until the mixture becomes transparent. Considering the initial volumes from the first data point along with the added water and ethanol mass from the second addition, a second data point is tabulated. This process is repeated until the turbid to transparent transition can no longer be observed visually, resulting in half of the binodal curve. To produce the other half of the curve, the process is repeated starting from equal volumes of HDA and water, but now 5% of HDA is incrementally added for each data point instead of water. The two data sets are joined to plot the experimentally determined binodal line of the HDA-water-ethanol ternary phase diagram. The corresponding ternary phase diagram is shown in FIG. 7A.

Structures of quenched emulsions with varying compositions are compared to determine the critical point along the binodal line. Four precursors (A, B, C, D) are prepared, with increasing ratios of oil-to-water; their compositions are listed in Table 1. Ethanol is added to create a miscible one-phase precursor, such that the composition is located above the binodal line in FIG. 7A. The precursors are extruded onto a glass slide, then quenched via ambient ethanol evaporation for one minute, followed by UV curing to form polymer-pore networks. With trace amount of hydrophobic fluorescent dyes (Nile red and BPA) introduced into the precursor and immersion fluid, we image the polymerized emulsions via CLSM as per the procedure in FIG. 7B, where green signal represents the polymerized oil phase and the red signal represents the permeated pore phase water that was formerly occupied by water. As seen in FIG. 7C, at a low oil-to-water ratios (composition A), oil-in-water emulsion structures are found. Similarly, at high oil-to-water ratios (composition D), water-in-oil emulsions form. Between the two, we observe a transition regime (compositions B and C), where bicontinuous emulsions form, indicating the system quenching into the spinodal region.

TABLE 1
Composition of precursors A, B, C, D along
binodal line in ternary phase diagram

| Component | A | | B | | C | | D | |
|---|---|---|---|---|---|---|---|---|
| HDA | 14.3 | vol % | 19.8 | vol % | 25.1 | vol % | 30.3 | vol % |
| Water | 33.8 | vol % | 31.9 | vol % | 28.5 | vol % | 24.8 | vol % |
| EtOH | 51.8 | vol % | 48.3 | vol % | 46.4 | vol % | 44.8 | vol % |
| LM-150 | 9.04 | wt % | 8.62 | wt % | 8.66 | wt % | 8.68 | wt % |
| TS-610 | 2.45 | wt % | 2.21 | wt % | 2.31 | wt % | 2.40 | wt % |
| HMP | 1.57 | wt % | 2.04 | wt % | 2.45 | wt % | 3.04 | wt % |

### Fumed Silica Wetting Behavior and Pore Phase Permeation

The effect of the ratio of hydrophilic-to-hydrophobic fumed silica is explored. To do so, precursors are prepared with hydrophilic ratios ranging from zero to one, where hydrophilic ratio is calculated as the mass ratio of hydrophilic fumed silica particles to total fumed silica particles. As such, a HR of zero implies all particles in the system are the hydrophobic variant, while a HR of one implies all particles in the system are the hydrophilic variant. These precursors are quenched and UV cured, and their structure is analyzed via CLSM.

For low HR, water-in-oil emulsions are produced as seen in FIG. 6A for a HR of 0.4. On the other hand, oil-in-water emulsions are found for high HRs, such as a value of 1.0 in FIG. 6C. For intermediate values, the fumed silica clusters can stabilize bicontinuous emulsions, as seen in FIG. 6B with an HR of 0.7. We identify a neutrally wetting region where bicontinuous emulsions are stabilized for HR between 0.6 and 0.8, agreeing with the previously reported value where fumed silica-based bijels were formed via STRIPS.¹

Further, pore continuity is explored via capillary driven permeation. Since DEP has a similar index of refraction as poly (HDA), we can visually monitor its flow within the pores of a dried, polymerized emulsion film. We suspend the dried films in the air and dip one end into a pool of DEP. As DEP infiltrates the film's pores via capillarity, the film transitions from a visually opaque to a visually transparent state; the behavior of the moving DEP front provides insight into the continuity of the pore phase. If there is no rise of DEP in the film, then the pores are classified as discrete which is consistent with water-in-oil emulsion behavior, as seen in FIG. 6A in the low HR scenario. If there is a rise of DEP like in FIGS. 6B and 6C, then there is some degree of pore phase continuity; we note this phenomenon is more prominent in the intermediate HR scenario, as the height of the DEP front is higher than the high HR scenario. This occurs since the pore sizes are smaller when bicontinuous emulsions are stabilized for intermediate HR, producing stronger capillarity. For high HR, the pores are still continuous but are larger and therefore capillarity is weaker; this behavior is consistent with oil-in-water structure.

### Size Determination of Fumed Silica Clusters Via Dynamic Light Scattering (DLS)

A DelsaNano C is used to measure the size of fumed silica clusters in each of the following diluents: water, HDA, and ethanol. Measurements are taken at 25° C. for each experiment. The following viscosity values are used: 0.8904 cP for water, 9 cP for HDA, and 1.102 cP for ethanol. Dispersions of LM-150 and TS-610 particles in water, HDA, and ethanol are prepared with a concentration of 2 wt %. Additional particles are added to some dispersions to increase signal intensity. The intensity distribution is collected for each dispersion. The peak size of the fumed silica dispersions is hundreds of nanometers. The cluster size changes for different diluents, as their dielectric constant varies. The diluents have the following dielectric constants: 78.4 for water, 24.55 for ethanol, and 8.3 for HDA.

### Hershel-Bulkley Fluid Parameters

The flow sweep stress vs. shear rate rheological data is fit to a Hershel-Bulkley fluid model, is defined by the equation σ=σ_y+kγγ\hat{ }n where σ is the shear stress, σ_y is the yield stress, k is the consistency factor, γ ′ is the shear rate, and n is the power-law flow index. The Hershel-Bulkley fluid parameters are summarized in Table 1, as the concentration of fumed silica in the precursor is increased. Further, we also note if the precursor is able to be printed via DIW extrusion in Table 1, for that given concentration of fumed silica.

TABLE 2
Hershel-Bulkley parameters from fitting stress vs. shear
rate data for bicontinuous emulsion gel precursors as
the fumed silica particle concentration is increased.

| SiO₂ content | Yield stress σ_{y} | k | n | Printable? |
|---|---|---|---|---|
| 12.6 wt % | 367 | 119 | 0.527 | Yes |
| 11.9 wt % | 24.0 | 108 | 0.273 | No |
| 10.6 wt % | 18.7 | 19.5 | 0.802 | No |
| 10.0 wt % | 4.33 | 12.2 | 0.564 | No |

### Surface Microstructure of 3D Printed Bicontinuous Emulsion Gels

We 3D print a bicontinuous emulsion gel with a geometry of a vertical rectangular prism. One of the four walls is cut from the structure and its surface is characterized via SEM in FIG. 10. When untreated, microstructures are observed; the occurs due to drying out of the emulsion before the UV curing process, resulting in the formation of oil-particle heavy features on the surface, as seen in FIG. 10A. However, by removed the particles via silica etching, the bicontinuous porous structure is revealed, indicated in FIG. 10B. The structures are similar to that of the cross-sectional images in FIG. 3C, suggesting structural uniformity throughout the 3D printed monolith.

### Pore Phase Continuity of a Polymerized 3D Printed Bicontinuous Emulsion

We test the pore continuity of a polymerized 3D printed bicontinuous emulsion by visually monitoring capillary-driven flow of DEP within the pores. Since DEP has a similar index of refraction of poly (HDA), the polymerized construct transitions from a visually white to a transparent state as DEP permeates across its pores (there is a slight pink hue due to the presence of Nile red). To do this, we create a bicontinuous emulsion gel via DIW, with a macroscale geometry of a wall. The emulsion gel is polymerized via UV curing, then dried, producing a porous wall that includes polymer and pore phases. One end of the wall is placed on a coverslip, while the other end rests over a pipette tip. DEP is added dropwise to the coverslip end; the DEP permeates into the wall's pores via capillarity, and the DEP moving front is observed visually across one hour. DEP is able to rise across the 3D printed wall, indicating continuity of the pore phase.

### Aspects

The following Aspects are illustrative only and do not limit the scope of the present disclosure or the appended claims. Any part or parts of any one or more Aspects can be combined with any part or parts of any one or more other Aspects.

In an aspect, the present disclosure provides a printable bijel precursor, comprising: a hydrophobic component; an aqueous component; a solvent; a population of hydrophobic particles; and a population of hydrophilic particles, wherein the printable bijel precursor is formulated such that the printable bijel precursor forms a bijel following at least partial removal of the solvent, wherein the printable bijel precursor is characterized as having any one or more of: (a) a viscosity of from about 20 to about 80 Pas at a shear rate of 15 sec-, (b) a storage modulus of from 6000 to about 60,000 Pa at a strain of 0.1%, (c) a loss modulus of from 600 to about 6000 Pa at a strain of about 0.1%, and (d) a loss modulus greater than a storage modulus at a strain of about 20%.

The viscosity at a shear rate of 15 sec can be, for example, form about 20 to about 80 Pa*s, from about 22 to about 78 Pa*s, from about 25 to about 75 Pa*s, from about 30 to about 70 Pa*s, from about 35 to about 65 Pa*s, from about 35 to about 60 Pa*s, from about 40 to about 55 Pa*s, or even from about 45 to about 50 Pa*s. It should be understood that the viscosity can be of any value, sub-range, or sub-ranges between about 20 about about 80 Pa*s.

The storage modulus can be from 6000 to about 60,000 Pa at a strain of 0.1%, or from 7500 to about 50,000 Pa at a strain of 0.1%, or from 10,000 to about 40,000 Pa at a strain of 0.1%, or from 15,000 to about 35,000 Pa at a strain of 0.1%, or from 20,000 to about 30,000 Pa at a strain of 0.1%.

The loss modulus can be from 600 to about 6000 Pa at a strain of about 0.1%, or from 1000 to about 5000 Pa at a strain of about 0.1%, or from 1200 to about 4500 Pa at a strain of about 0.1%, or from 1500 to about 3500 Pa at a strain of about 0.1%.

In an aspect, the hydrophobic component comprises a species that can be converted to a solid. Such a species can be, for example, a polymerizable species. Oils are considered particularly suitable.

In an aspect, the polymerizable species can comprise an organic diacrylate, the organic diacrylate optionally comprising 1,6 hexanediol diacrylate.

In an aspect, the hydrophobic particles comprise hydrophobic fumed silica.

In an aspect, the hydrophilic particles comprise hydrophilic fumed silica.

In as aspect, the aqueous component comprises water.

In an aspect, the solvent comprises any one or more of an alcohol, an ether, and a ketone. An alcohol can be, for example, ethanol, although other alcohols can be used. A solvent can also be, for example, a ketone, such as acetone. A solvent can also be, for example, an ether, such as THF.

In an aspect, the printable bijel precursor further comprises a photoinitiator. Suitable photoinitiators are known to those of ordinary skill in the art, and can be selected based on other components that are present.

In an aspect, the ratio of the mass of the hydrophilic particles to the mass of the hydrophilic particles added to the mass of the hydrophobic particles is in the range of from about 0.2 to about 0.8, for example from about 0.4 to about 0.8, or even about 0.6 to about 0.8. The mass of the hydrophobic particles can be considered the total mass of the hydrophobic particles, and the mass of the hydrophilic particles can be considered to be the total mass of the hydrophilic particles.

In an aspect, the present disclosure provides a method of additively manufacturing a bijel, comprising: extruding a first amount of a printable bijel precursor according to the present disclosure, the extruding being performed under such conditions that the first amount of the printable bijel precursor forms a first solid persistent bijel portion. The conditions can include, for example, effecting at least partial evaporation of the solvent of the printable bijel precursor.

In an aspect, the method further comprises extruding a second amount of the printable bijel precursor atop the first amount of the printable bijel precursor under such conditions that the second printable bijel precursor forms a second solid persistent bijel portion, the second solid persistent bijel portion surmounting the first solid persistent bijel portion.

In an aspect, the method further comprises polymerizing the hydrophobic component of the printable bijel precursor.

In an aspect, the present disclosure provides a method of additively manufacturing a bijel part, comprising: extruding, through a nozzle having a diameter, a plurality of layers of a printable bijel precursor according to the present disclosure, the extruding being performed under such conditions that the printable bijel precursor forms a solid persistent bijel part comprising a plurality of bijel layers.

In an aspect, the method further comprises polymerizing the hydrophobic component of the printable bijel precursor.

In an aspect, the extruding is in accordance with a predetermined schedule. As an example, the extruding can be performed in accordance with a printing path that gives rise to a desired bijel part. The printing path can include, for example, a curved segment, a straight segment, or both. The printing path can be continuous, but this is not a requirement, as the printing path can be discontinuous.

In an aspect, the bijel part is configured as a biomedical implant or a reactor.

In an aspect, the present disclosure also provides a bijel part, comprising: a plurality of layers comprising a persistent solid bijel material, the plurality of layers comprising channels placing the layers into fluid communication with one another.

In an aspect, the bijel part defines a wall enclosing an interior volume. A wall can be, for example, curved, polygonal, and the like.

In an aspect, the bijel part defines pores therein, the pores having a characteristic cross-sectional dimension of from about 1 to about 10 microns. Pores can have a cross-sectional dimension of from about 2 to about 9 microns, from about 3 to about 7 microns, or even from about 4 to about 6 microns.

In an aspect, the bijel part can be incorporated into a separation device, an extraction device, a coating, an electrode, or a hydrogel. The bijel part can be placed or otherwise configured such that fluid contacts the bijel part.

What is claimed:

1. A printable bijel precursor, comprising:
a hydrophobic component;
an aqueous component;
a solvent;
a population of hydrophobic particles; and
a population of hydrophilic particles,
wherein the printable bijel precursor is formulated such that the printable bijel precursor forms a bijel following at least partial removal of the solvent,
wherein the printable bijel precursor is characterized as having any one or more of:
(a) a viscosity of from about 20 to about 80 Pa*s at a shear rate of 15 sec⁻¹,
(b) a storage modulus of from 6000 to about 60,000 Pa at a strain of 0.1%,
(c) a loss modulus of from 600 to about 6000 Pa at a strain of about 0.1%, and
(d) a loss modulus greater than a storage modulus at a strain of about 20%.

2. The printable bijel precursor of claim 1, wherein the hydrophobic component comprises a species convertible to a solid, the species optionally being a polymerizable species.

3. The printable bijel precursor of claim 2, wherein the polymerizable species comprises an organic diacrylate, the organic diacrylate optionally comprising 1,6 hexanediol diacrylate.

4. The printable bijel precursor of claim 1, wherein the hydrophobic particles comprise hydrophobic fumed silica.

5. The printable bijel precursor of claim 1, wherein the hydrophilic particles comprise hydrophilic fumed silica.

6. The printable bijel precursor of claim 1, wherein the aqueous component comprises water.

7. The printable bijel precursor of claim 1, wherein the solvent comprises any one or more of an alcohol, an ether, and a ketone.

8. The printable bijel precursor of claim 1, further comprising a photoinitiator.

9. The printable bijel precursor of claim 1, wherein ratio of the mass of the hydrophilic particles to the mass of the hydrophilic particles added to the mass of the hydrophobic particles is in the range of from about 0.2 to about 0.8, optionally from about 0.6 to about 0.8.

10. A method of additively manufacturing a bijel, comprising:
extruding a first amount of a printable bijel precursor according to claim 1,
the extruding being performed under such conditions that the first amount of the printable bijel precursor forms a first solid persistent bijel portion.

11. The method of claim 10, further comprising extruding a second amount of the printable bijel precursor atop the first amount of the printable bijel precursor under such conditions that the second printable bijel precursor forms a second solid persistent bijel portion, the second solid persistent bijel portion surmounting the first solid persistent bijel portion.

12. The method of claim 10, further comprising polymerizing the hydrophobic component of the printable bijel precursor.

13. A method of additively manufacturing a bijel part, comprising:
extruding, through a nozzle having a diameter, a plurality of layers of a printable bijel precursor according to claim 1,
the extruding being performed under such conditions that the printable bijel precursor forms a solid persistent bijel part comprising a plurality of bijel layers.

14. The method of claim 13, further comprising polymerizing the hydrophobic component of the printable bijel precursor.

15. The method of claim 13, wherein the extruding is in accordance with a predetermined schedule.

16. The method of claim 13, wherein the bijel part is configured as a biomedical implant or a reactor.

17. A bijel part, comprising:
a plurality of layers comprising a persistent solid bijel material,
the plurality of layers comprising channels placing the layers into fluid communication with one another.

18. The bijel part of claim 17, wherein the bijel part defines a wall enclosing an interior volume.

19. The bijel part of claim 17, wherein the bijel part defines pores therein, the pores having a characteristic cross-sectional dimension of from about 1 to about 10 microns.

20. The bijel part of claim 17, wherein the bijel part is incorporated into a separation device, an extraction device, a coating, an electrode, or a hydrogel.
